(19) United States
(12) Patent Application Publication
(10) Pub. No.: US 2008/0207228 A1
(43) Pub. Date: Aug. 28, 2008

(54) METHOD AND APPARATUS FOR REDUCING CALL SETUP DELAY BY INCLUDING INTERFERENCE INFORMATION IN PAGING MESSAGE

(75) Inventors: Amer Catovic, San Diego, CA (US); Alvin Siu-Chung Ng, Hong Kong (HK); Mohit Narang, Escondido, CA (US); Chan Chun Chung Patrick, Hong Kong (CN)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/021,997

(22) Filed: Jan. 29, 2008

Related U.S. Application Data
(60) Provisional application No. 60/887,588, filed on Jan. 31, 2007.

(51) Int. Cl. H04Q 7/20

(52) U.S. Cl. 455/458

(57) ABSTRACT

An apparatus and method for reducing call setup time of a wireless communication device including determining an uplink interference information, including the uplink interference information in a paging message to be sent on a Common Control Channel and sending the paging message on the Common Control Channel. In one aspect, the paging message is received, the uplink interference information from the received paging message is obtained, and a RRC connection request message is sent in response to the received paging message.

### CLAIM OF PRIORITY UNDER 35 U.S.C. §119

The present application for patent claims priority to Provisional Application No. 60/887,588 entitled “Methods and Apparatus for Reducing Mobile Terminated Call Setup Delay by Including Interference Information in the Paging Message” filed Jan. 31, 2007, and assigned to the assignee hereof and hereby expressly incorporated by reference herein.

### REFERENCE TO CO-PENDING APPLICATIONS FOR PATENT

The present application for patent is related to the following co-pending U.S. patent applications:

“Method and Apparatus For Reducing Call Setup Delay By Adjusting SIB7 and SIB14 Scheduling Frequency” by Chan Chun Chung Patrick, Amer Catovic; Mohit Narang and Alvin Siu-Chung Ng, having Attorney Docket No. 070639, filed concurrently herewith, assigned to the assignee hereof, and expressly incorporated by reference herein; and
“Method and Apparatus For Reducing Cal Setup Delay by Improved SIB7 and SIB14 Scheduling” by Alvin Siu-Chung Ng; Amer Catovic; Mohit Narang and Chan Chun Chung Patrick having Attorney Docket No. 070632, filed concurrently herewith, assigned to the assignee hereof, and expressly incorporated by reference herein

### FIELD

This disclosure relates generally to apparatus and methods for reducing call setup time. More particularly, the disclosure relates to reducing call setup time by including interference information in the paging message.

### BACKGROUND

Mobile terminated (MT) call setup time is a key performance indicator in wireless networks. It has a direct effect on the user's experience regardless of any service offered by the network. Mobile terminated call setup time has a substantial impact on the overall revenue generated by the network as well as the churn rate. In cellular wireless networks, when the user equipment (UE) is idle, it wakes up at regular time intervals in order to check paging and read system information broadcast by the network. Current formats of wireless communication systems include the third generation (3G) systems which provide greater capacity and more broadband wireless capabilities than the previous 2G systems. The 3G systems include a Common Control Channel that broadcast system information from the wireless network to the UEs. One emerging 3G system is Universal Mobile Telecommunications Systems (UMTS). In UMTS, there are several Common Control Channels. For example, there are different information blocks on the Primary Common Control Physical Channel (P-CCPCH) in UMTS, categorized into Master Information Blocks (MIBs) and System Information Blocks (SIBs).

For example, each SIB carries a particular type of network information, such as but not limited to, Public Land Mobile Network (PLMN) info, DRX cycle coefficient (SIB1), thresholds for cell reselection (SIB3), current uplink interference information (SIB7, SIB14), paging frequency, timers, etc. The broadcast scheduling of these system information blocks is contained in the master information block (MIB) which is broadcasted in regular, pre-determined time intervals. MIB contains the exact repetition count, number of segments and system frame number for each of the SIBs broadcasted. One of the SIBs is SIB7 (or SIB14) which carries the up-to-date uplink interference information perceived by the base station receiver. Each UE needs to read SIB7 (or SIB14) of the camping cell before establishing a connection with the network. The SIB7 (or SIB14) information contains the uplink interference level (a.k.a. uplink interference information) which is used in the open loop power control calculation to determine the appropriate transmit power level for random access. Additionally, the UE decodes its paging block in order to determine if the UE is being paged by the network. In some instances, reading the SIB7 (or SIB14) and being paged by the network can occur simultaneously or near simultaneously.

The paging block is broadcasts through the Secondary Common Control Physical Channel (S-CCPCH). Typically, the decoding of the paging block (on S-CCPCH) has higher priority over the decoding of SIBs (on P-CCPCH). When the UE is being paged, it cannot immediately initiate a connection with the network to respond to the page until the UE has received the next occurrence of broadcasted SIB7 (or SIB14). As a result, there is a necessary waiting time between the receipt of die page and connection request initiation with the network. The waiting time can vary among different UEs, some waiting time being longer than desirable to ensure good user experience.

### SUMMARY

Disclosed is an apparatus and method for reducing mobile terminated (MT) call setup time. By including uplink interference information in the paging message as disclosed herein, advantageous results may include reducing MT call setup time, reducing waiting time for the next occurrence of SIB7 (or SIB14), increasing call success rate performance, and hence, ensuring better user experience. For example, by including uplink interference information in the paging message, the user equipment can respond to the page as soon as the paging message is received.

According to one aspect, a method for reducing call setup time of a wireless communication device comprising determining an uplink interference information; and including the uplink interference information in a paging message to be sent on a Common Control Channel, thereby reducing call setup time. In one aspect, the method of further comprises sending the paging message on the Common Control Channel.

According to another aspect, a method for reducing call setup time of a wireless communication device comprising receiving a paging message including an uplink interference information; obtaining the uplink interference information from the received paging message; and responding to the received paging message using the uplink interference information by sending a RRC connection request message.

According to another aspect, a method for reducing call setup time of a wireless communication device comprising: determining an uplink interference information; including the uplink interference information in a paging message to be sent on a Common Control Channel; sending the paging message on the Common Control Channel; receiving the paging message; obtaining the uplink interference information from the received paging message; and responding to the received paging message using the uplink interference information by sending a RRC connection request message.

According to another aspect, an apparatus comprising a processor and a memory the memory containing program code executable by the processor for performing the following: determining an uplink interference information; and including the uplink interference information in a paging message to be sent on a Common Control Channel, thereby reducing call setup time.

According to another aspect, an apparatus comprising a processor and a memory, the memory containing program code executable by the processor for performing the following: receiving a paging message including an uplink interference information; obtaining the uplink interference information from the received paging message; and responding to the received paging message using the uplink interference information by sending a RRC connection request message.

According to another aspect, an apparatus for reducing call setup time comprising means for determining an uplink interference information; and means for including the uplink interference information in a paging message to be sent on a Common Control Channel, thereby reducing call setup time.

According to another aspect, an apparatus for reducing call setup time comprising means for receiving a paging message including an uplink interference information; means for obtaining the uplink interference information from the received paging message; and means for responding to the received paging message using the uplink interference information by sending a RRC connection request message.

According to another aspect, a computer-readable medium including program code stored thereon, comprising program code for causing a computer to determine an uplink interference information; and program code for causing the computer to include the uplink interference information in a paging message to be sent on a Common Control Channel, thereby reducing call setup time.

According to another aspect, a computer-readable medium including program code stored thereon, comprising program code for causing a computer to receive a paging message including an uplink interference information; program code for causing the computer to obtain the uplink interference information from the received paging message; and program code for causing the computer to respond to the received paging message using the uplink interference information by sending a RRC connection request message.

According to another aspect, a computer-readable medium including program code stored thereon, which when executed by at least one computer implement a method, comprising program code for determining an uplink interference information; program code for including the uplink interference information in a paging message to be sent on a Common Control Channel; program code for sending the paging message on the Common Control Channel; program code for receiving the paging message; program code for obtaining the uplink interference information from the received paging message; and program code for responding to the received paging message using the uplink interference information by sending a RRC connection request message.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram illustrating an exemplary wireless network.

FIGS. 2a and 2b illustrate the timeline overlap of paging blocks and SIB broadcast blocks.

FIG. 3 illustrates an exemplary P-CCPCH and S-CCPCH timeline which includes the uplink interference information in the paging message.

FIG. 4 is a flow diagram illustrating a set of exemplary steps for reducing call setup time.

FIG. 5 illustrates all implementation for reducing call setup time.

FIG. 6 illustrates an embodiment of a device suitable for reducing call setup time.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Scheduling and the repetition time of SIB7 (or SIB14) broadcasts are constant and set by the network. Paging occasions are also determined based on the International Subscriber Mobile Identity (IMSI) of the UE. As a result of these standards, the waiting time between the receipt of a page and connection request initiation with the network for the UE will depend on the paging-groups to which the UE belongs. For example, if the UE belongs to the paging group that is adjacent to the next SIB7 (or SIB14) scheduling slot, the UE will experience the smallest waiting time. In contrast, if the UE belongs to the paging group that overlaps between the paging blocks and SIB7 (or SIB14), the decoding of the paging has higher priority (by convention), and the UE will miss the decoding, of the SIBs. In such a case, the UE will experience the largest waiting time and experience consistently the largest MT call setup times.

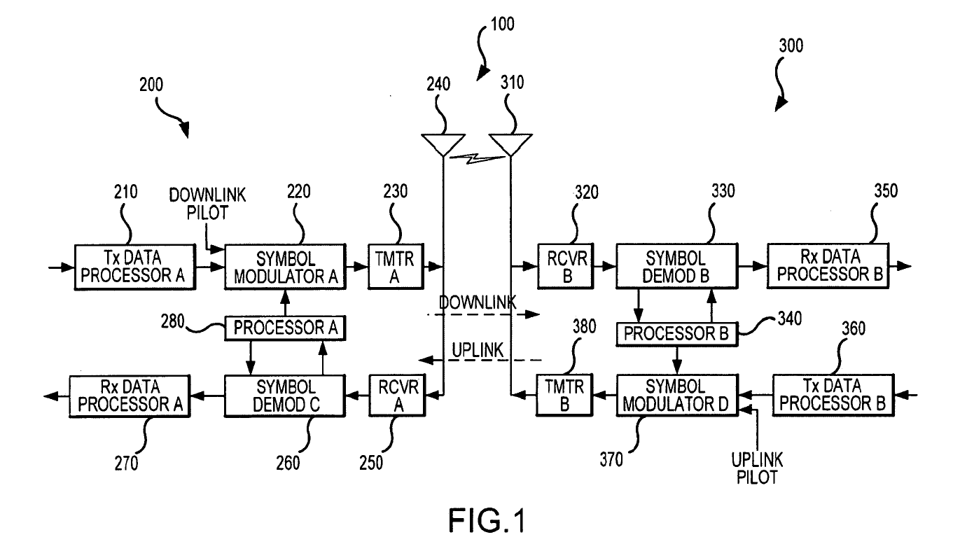

FIG. 1 is a block diagram illustrating an exemplary wireless network 100. One skilled in the art would understand that the exemplary wireless network 100 illustrated in FIG. 1 may be implemented in an FDMA environment, an OFDMA environment, a CDMA environment, a WCDMA environment, a TDMA environment, a SDMA environment or any other suitable wireless environment.

The wireless network 100 includes an access point 200 (a.k.a. base station) and a wireless communication device 300 (a.k.a. user equipment or UE). In the downlink leg, the access point 200 (a.k.a. base station) includes a transmit (TX) data processor A 210 that receives, formats, codes, interleaves and modulates (or symbol maps) traffic data and provides modulation symbols (a.k.a. data symbols). The TX data processor A 210 is in communication with a symbol modulator A 220. The symbol modulator A 220 receives and processes the data symbols and downlink pilot symbols and provides a stream of symbols. In one aspect, symbol modulator A 220 is in communication with processor A 280 which provides configuration information. Symbol modulator A 220 is in communication with a transmitter unit (TMTR) A 230. The symbol modulator A 220 multiplexes the data symbols and downlink pilot symbols and provides them to the transmitter unit A 230.

Each symbol to be transmitted may be a data symbol, a downlink pilot symbol or a signal value of zero. The downlink pilot symbols may be sent continuously in each symbol period. In one aspect, the downlink pilot symbols are frequency division multiplexed (FDM). In another aspect, the downlink pilot symbols are orthogonal frequency division multiplexed (OFDM). In yet another aspect, the downlink pilot symbols are code division multiplexed (CDM). In one aspect, the transmitter unit A 230 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 240.

In the downlink leg, the wireless communication device 300 (a.k.a. UE) includes antenna 310 for receiving the analog downlink signal and inputting the analog downlink signal to a receiver unit (RCVR) B 320. In one aspect, the receiver unit B 320 conditions, for example, filters, amplifies and frequency downconverts the analog downlink signal to a “conditioned” signal. The “conditioned” signal is then sampled. The receiver unit B 320 is in communication with a symbol demodulator B 330. The symbol demodulator B 330 demodulates the “conditioned” and “sampled” signal (a.k.a. data symbols) outputted from the receiver unit B 320. The symbol demodulator B 330 is in communication with a processor B 340. Processor B 340 receives downlink pilot symbols, from symbol demodulator B 330 and performs channel estimation on the downlink pilot symbols. In one aspect, the channel estimation is the process of characterizing the current propagation environment. The symbol demodulator B 330 receives a frequency response estimate for the downlink leg from processor B 340. The symbol demodulator B 330 performs data demodulation on the data symbols to obtain data symbol estimates. The data symbol estimates are estimates of the data symbols that were transmitted. The symbol demodulator B 330 is also in communication with a RX data processor B 350. The RX data processor B 350 receives the data symbol estimates from the symbol demodulator B 330 and, for example, demodulates (i.e., symbol demaps), interleaves and/or decodes the data symbol estimates to recover the traffic data. In one aspect, the processing by the symbol demodulator B 330 and the RX data processor B 350 is complementary to the processing by the symbol modulator A 220 and TX data processor A 210, respectively.

In the uplink leg, the wireless communication device 300 (a.k.a. UE) includes a TX data processor B 360. The TX data processor B 360 receives and processes traffic data to output data symbols. The TX data processor B 360 is in communication with a symbol modulator D 370. The symbol modulator D 370 receives and multiplexes the data symbols with uplink pilot symbols, performs modulation and provides a stream of symbols. In one aspect, symbol modulator D 370 is in communication with processor B 340 which provides configuration information. The symbol modulator D 370 is in communication with a transmitter unit B 380.

Each symbol to be transmitted may be a data symbol, an uplink pilot symbol or a signal value of zero. The uplink pilot symbols may be sent continuously in each symbol period. In one aspect, the uplink pilot, symbols are frequency division multiplexed (FDM). In another aspect, the uplink pilot symbols are orthogonal frequency division multiplexed (OFDM). In yet another aspect, the uplink pilot symbols are code division multiplexed (CDM). In one aspect, the transmitter unit B 380 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 310.

The analog uplink signal from wireless communication device (UE) 300 is received by antenna 240 and processed by a receiver unit A 250 to obtain samples. In one aspect, the receiver unit A 250 conditions, for example, filters, amplifies and frequency downconverts the analog uplink signal to a “conditioned” signal. The “conditioned” signal is then sampled. The receiver unit A 250 is in communication with a symbol demodulator C 260. The symbol demodulator C 260 performs data demodulation on the data symbols to obtain data symbol estimates and then provides the uplink pilot symbols and the data symbol estimates to the RX data processor A 270. The data symbol estimates are estimates of the data symbols that were transmitted. The RX data processor A 270 processes the data symbol estimates to recover the traffic data transmitted by the wireless communication device 300. The symbol demodulator C 260 is also in communication with processor A 280. Processor A 280 performs channel estimation for each active terminal transmitting on the uplink leg. In one aspect, multiple terminals may transmit pilot symbols concurrently on the uplink leg on their respective assigned sets of pilot subbands where the pilot subband sets may be interlaced.

Processor A 280 and processor B 340 direct (i.e., control, coordinate or manage, etc.) operation at the access point 200 (a.k.a. base station) and at the wireless communication device 300 (a.k.a. user equipment or UE), respectively. In one aspect, either or both processor A 280 and processor B 340 are associated with one or more memory units (not shown) for storing of program codes and/or data. In one aspect, either or both processor A 280 or processor B 340 or both perform computations to derive frequency and impulse response estimates for the uplink leg and downlink leg, respectively.

In one aspect, the wireless network 100 is a multiple-access system. For a multiple-access system (e.g., FDMA, OFDMA, CDMA, TDMA, etc.), multiple terminals transmit concurrently on the uplink leg. In one aspect, for the multiple-access system, the pilot subbands may be shared among different terminals. Channel estimation techniques are used in cases where the pilot subbands for each terminal span the entire operating band (possibly except for the band edges). Such a pilot subband structure is desirable to obtain frequency diversity for each terminal.

One skilled in the art would understand that the techniques described herein may be implemented by various ways. For example, the techniques may be implemented in hardware, software or a combination thereof. For example, for a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that performs the functions described therein. The software codes may be stored in memory units and executed by processor A 280 and processor B 340.

The various illustrative flow diagrams, logical blocks, modules, and/or circuits described herein may be implemented or performed with one or more processor units (a.k.a. processor). A processor may be a general purpose processor, such as a microprocessor, a specific application processor, such a digital signal processor (DSP), or any other hardware platform capable of supporting software. Software shall be construed broadly to mean any combination of instructions, data structures, or program code, whether referred to as software, firmware, middleware, microcode, or any other terminology. Alternatively, a processor may be an application specific integrated circuit (ASIC), a programmable logic device (PLD), a field programmable gate array (FPGA), a controller, a micro-controller, a state machine, a combination of discrete hardware components, or any combination thereof. The various illustrative logical blocks, modules, and/or circuits described herein may also include computer readable medium for storing software. The computer readable medium may also include one or more storage devices, a transmission line, or a carrier wave that encodes a data signal.

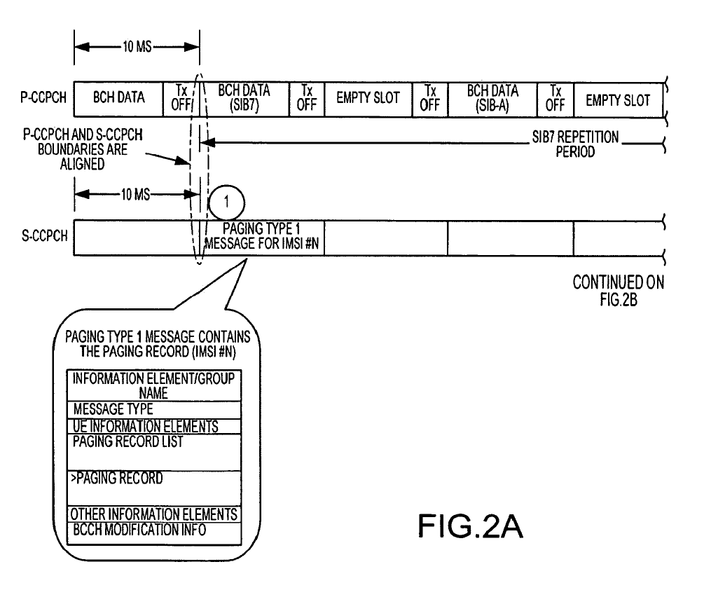

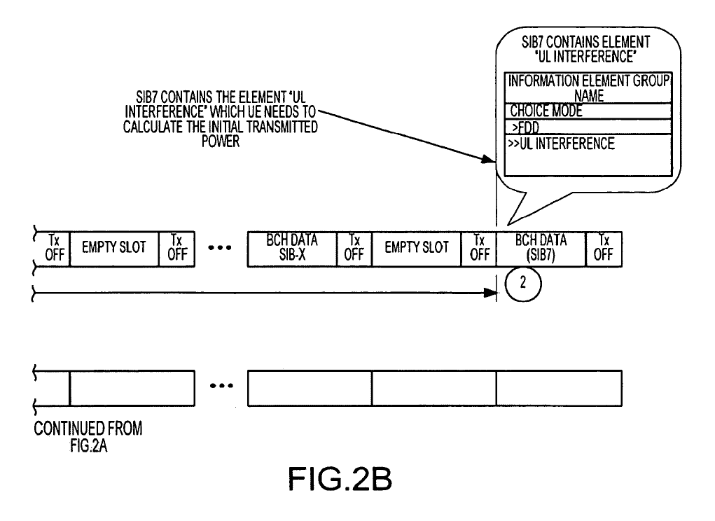

FIGS. 2a and 2b illustrate the timeline overlap of paging blocks and SIB broadcast blocks. When the wireless network 100 pages the wireless communication device 300 (a.k.a. UE), it sets the paging indicator (PI) corresponding to the wireless communication device 300 (a.k.a. UE) on the paging indicator channel (PICH). In one aspect, one or more wireless communication devices can be assigned to the same PI. Each wireless communication device monitors only specific frames (a.k.a. paging occasions) on the PICH in order to determine the value of its PI. In one aspect, the system frame number (SFN) of the paging occasion for each wireless communication device is calculated as:

SFN={(IMSI div K)mod DRX cycle length}+n*DRX cycle length+frame offset (1)
where K is the number of S-CCPCH channels in a cell; DRX cycle length is a configurable parameter set by the wireless network; IMSI is the International Mobile Subscriber Identity which is a fixed number assigned by the wireless network to each subscriber and n=0, 1, 2, . . . as long as SFN is less than maximum (<256). In one example, K is set to 1.

If the wireless communication device 300 (a.k.a. UE) determines that its PI on the PICH is set, the wireless communication device 300 (a.k.a. UE) will read the paging channel (PCH) to determine if the incoming page is destined for itself. PCH is mapped onto a Common Control Channel. In one aspect, the Common Control Channel is the Secondary Common Control Physical Channel (S-CCPCH) in UMTS. In some instances, the transmission of the paging block overlaps with the broadcast of SIBs that the wireless communication device 300 (a.k.a. UE) needs to read for starting random access. The paging block that is broadcasted through the Secondary Common Control Physical Channel (S-CCPCH) typically has higher priority over the decoding of SIBs (on P-CCPCH). Hence, the wireless communication device 300 (a.k.a. UE) will read the paging block and miss the SIBs. In particular, if the paging block overlaps with SIB7, the wireless communication device 300 (a.k.a. UE) will miss decoding the SIB7. When the wireless communication device 300 (a.k.a. UE) is being paged, it cannot immediately initiate a connection with the wireless network to respond to the page until it has received the next occurrence of broadcasted SIB7, resulting in a waiting time between the receipt of the page and connection request initiation with the wireless network 100. The SIB7 information contains the uplink interference level which is used in the open loop power control calculation to determine the appropriate transmit power level for random access.

As shown in FIGS. 2a and 2b, item 1 is the paging type 1 message intended for IMSI #N. Item 2 is the BCH data containing the SIB7 intended for the wireless communication device 300 (a.k.a. UE) with IMSI #N. The wireless communication device 300 (a.k.a. UE) has to decode SIB7 before it can respond to the page. In this example, however, since the paging block overlaps the SIB7, the wireless communication device 300 (a.k.a. UE) would need to wait for the next occurrence of SIB7. Thus, in this example, the wireless communication device 300 (a.k.a. UE) will have the worst MT call setup time.

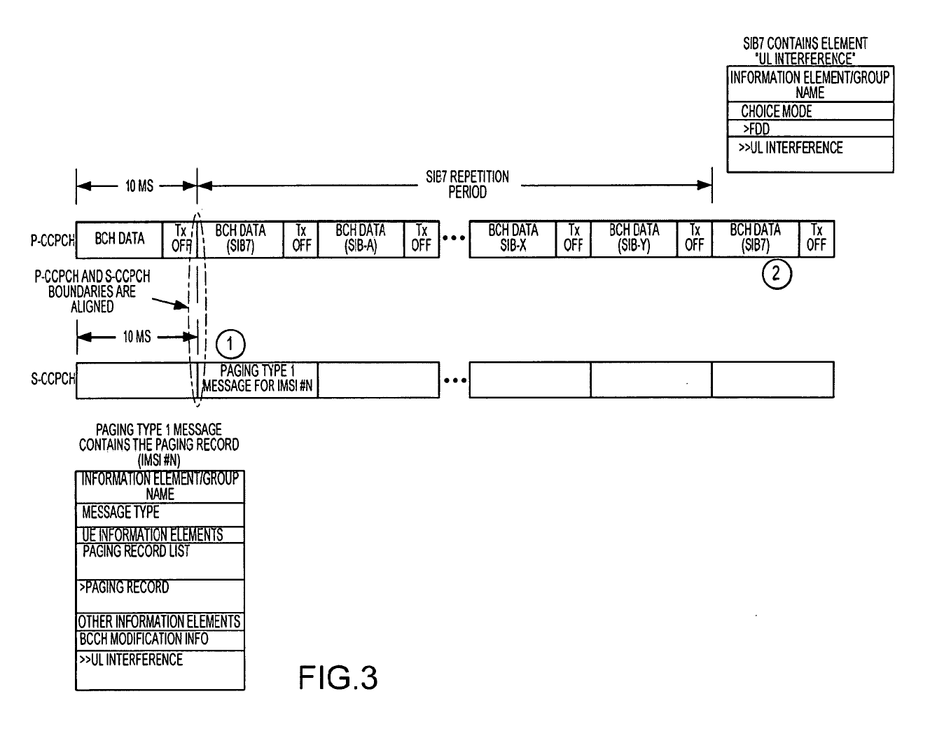

FIG. 3 illustrates an exemplary P-CCPCH and S-CCPCH timeline which includes the uplink interference information in the paging message. FIG. 3 shows that in addition to the existing broadcasted SIB7 (or SIB14) which comes at a constant repetition rate, the UTRAN (UMTS Terrestrial Radio Access Network) appends uplink interference information to the paging message and sends the paging message and the uplink interference information simultaneously. In one example, the paging type 1 message is intended for IMSI #N. The uplink interference information is included as part of the paging type 1 message to eliminate the waiting time for the next SIB7 (or SIB14) occurrence. This allows the wireless communication device 300 (a.k.a. user equipment or UE) to immediately respond to the page by sending the RRC connection request message and eliminate waiting time for the next SIB7 (or SIB14).

By including uplink interference information in the paging message as disclosed herein, advantageous results may include reducing MT call setup time, reducing waiting time for the next occurrence of SIB7 or SIB14, increasing call success rate performance, and hence, ensuring better user experience. For example, by including uplink interference information in the paging message, the user equipment can respond to the page as soon as the paging type 1 message is received.

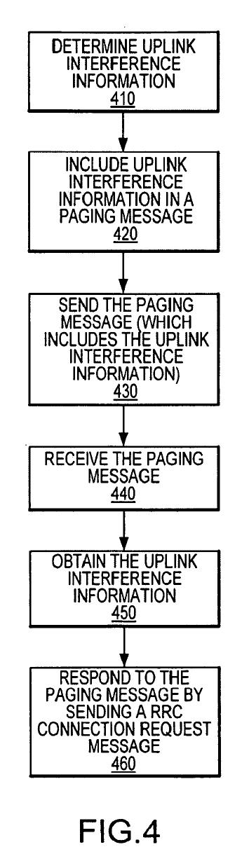

FIG. 4 is a flow diagram illustrating a set of exemplary steps for reducing call setup time. In block 410, the wireless network 100 determines the uplink interference information. Once the uplink interference information is determined, the uplink interference information is included in the paging message (e.g., a paging type 1 message) in block 420. In block 430, the paging message, which includes the uplink interference information, is sent on a Common Control Channel. In one aspect, the Common Control Channel in this step is S-CCPCH.

In block 440, the wireless communication device 300 receives the paging message, and in block 450, it obtains the uplink interference information. For example, after receiving the paging message, the wireless communication device 300 processes (i.e., decodes) the uplink interference information received. In one aspect, the uplink interference information is used in an open loop power control calculation to determine an appropriate transmit power level for the wireless communication device 300. In one aspect, the processing may include storing the uplink interference information, starting an expiration timer with a predefined value and considering the uplink interference information valid until the expiration timer expires. One skilled in the art would understand that the predefined value may be based on system parameters or operator choice, etc., without affecting the scope and spirit of the disclosure.

In one aspect, decoding and managing of the uplink interference information from the paging message is the task of the Radio Resource Controller (RRC). In one aspect, the RRC is part of the wireless communication device 300 (a.k.a. UE). The RRC reads and decodes the uplink interference information. In block 460, the wireless communication device 300 responds to the page (i.e., paging message) by sending the RRC connection request message to the wireless network 100 after it has obtained the uplink interference information. The inclusion of the uplink interference information in the paging message as disclosed herein allows for advantageous results such as reducing MT call setup time, reducing waiting time for the next occurrence of SIB7 or SIB14, increasing call success rate performance, and hence, ensuring better user experience. For example, by including uplink interference information in the paging message, the wireless communication device 300 (a.k.a. UE) can respond to the page as soon as the paging message is received. Ono skilled in the art would understand that not all the steps presented in FIG. 4 need to be used or that other steps can be combined with the steps presented in FIG. 4 without affecting the scope or spirit of the disclosure.

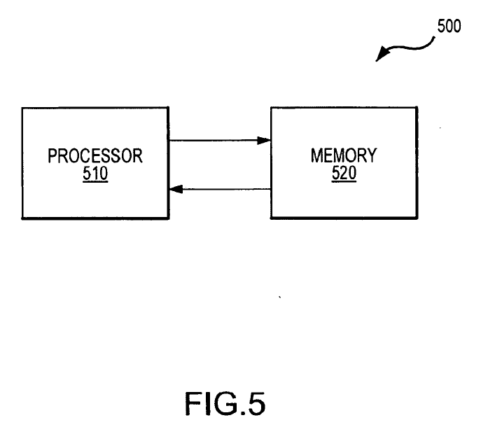

In one example, the implementation of reducing call setup time is achieved through device 500 which comprises a processor 510 in communication with a memory 520 as shown in FIG. 5. In one aspect, the memory 520 is located within the processor 510. In another aspect, the memory 520 is external to the processor 510. In one aspect, the exemplary steps shown in FIG. 4 is executed by the implementation (device 500) shown in FIG. 5.

One skilled in the art would understand that in one aspect, the disclosure relates to Frequency Division Duplex (FDD) mode in which the uplink interference information is contained in SIB7 blocks. Additionally, one skilled in the art would understand that in Time Division Duplex (TDD) mode, uplink interference information is contained in SIB14 blocks and that the disclosure herein referencing SIB7 blocks could be substituted with SIB14 blocks without affecting the scope or spirit of the disclosure.

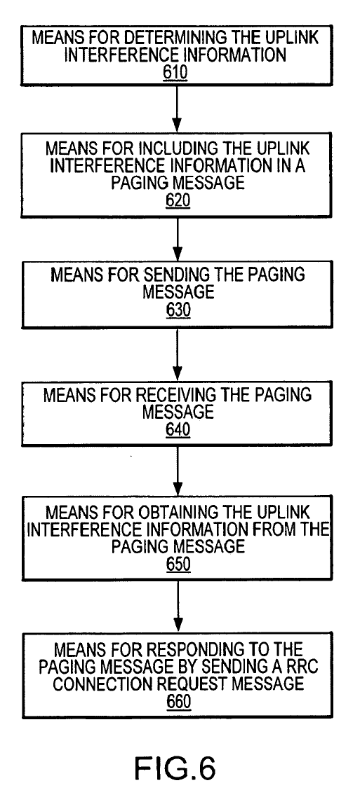

FIG. 6 shows an embodiment of a device 600 suitable for reducing call setup time. In one aspect, the device 600 is implemented by at least one processor comprising one or more modules configured to provide different aspects of reducing call setup time as described herein in blocks 610, 620, 630, 640, 650 and 660. For example, each module comprises hardware, software or any combination thereof. In one aspect, the device 600 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for reducing call setup time of a wireless communication device comprising:
determining an uplink interference information; and
including the uplink interference information in a paging message to be sent on a Common Control Channel, thereby reducing call setup time.

2. The method of claim 1 further comprising sending the paging message on the Common Control Channel.

3. The method of claim 2 wherein the wireless communication device is part of a 3G system.

4. The method of claim 3 wherein the wireless communication device is part of a UMTS.

5. The method of claim 4 wherein the Common Control Channel is an S-CCPCH.

6. The method of claim 2 wherein a wireless network performs sending the paging message on the Common Control Channel.

7. The method of claim 6 wherein the wireless network is a 3G system.

8. The method of claim 7 wherein the 3G system is UMTS.

9. The method of claim 1 further comprising receiving the paging message on the Common Control Channel.

10. The method of claim 9 wherein the Common Control Channel is an S-CCPCH.

11. The method of claim 9 further comprising obtaining the uplink interference information from the received paging message.

12. The method of claim 11 further comprising storing the obtained uplink interference information, starting an expiration timer and considering the obtained uplink interference information valid until the expiration timer expires.

13. The method of claim 11 further comprising responding to the received paging message using the uplink interference information by sending a RRC connection request message.

14. The method of claim 13 wherein the uplink interference information is used in an open loop power control calculation to determine an appropriate transmit power level for the wireless communication device.

15. A method for reducing call setup time of a, wireless communication device comprising:
receiving a paging message including an uplink interference information;
obtaining the uplink interference information from the received paging message; and
responding to the received paging message using the uplink interference information by sending a RRC connection request message.

16. The method of claim 15 further comprising storing the obtained uplink interference information, starting an expiration timer and considering the obtained uplink interference information valid until the expiration timer expires.

17. The method of claim 15 wherein the uplink interference information is used in an open loop power control calculation to determine an appropriate transmit power level for the wireless communication device.

18. The method of claim 17 wherein the wireless communication device is part of a 3G system.

19. The method of claim 18 wherein the wireless communication device is part of a UMTS.

20. A method for reducing call setup time of a wireless communication device comprising:
determining an uplink interference information;
including the uplink interference information in a paging message to be sent on a Common Control Channel;
sending the paging message on the Common Control Channel;
receiving the paging message;
obtaining the uplink interference information from the received paging message; and
responding to the received paging message using the uplink interference information by sending a RRC connection request message.

21. The method of claim 2( ) wherein the wireless communication device is part of a 3G system.

22. The method of claim 21 wherein the wireless communication device is part of a UMTS.

23. The method of claim 22 wherein the Common Control Channel is an S-CCPCH.

24. The method of claim 23 wherein a wireless network performs sending the paging message.

25. The method of claim 24 wherein the wireless network is a 3G system.

26. The method of claim 25 wherein the 3G system is UMTS.

27. The method of claim 26 further comprising storing the obtained uplink interference information, starting an expiration timer and considering the obtained uplink interference information valid until the expiration timer expires.

28. An apparatus comprising a processor and a memory, the memory containing program code executable by the processor for performing the following:
determining an uplink interference information; and
including the uplink interference information in a paging message to be sent on a Common Control Channel, thereby reducing call setup time.

29. The apparatus of claim 28 wherein the memory further comprising program code for sending the paging message on the Common Control Channel.

30. The apparatus of claim 29 wherein the apparatus is part of a UMTS and the Common Control Channel is an S-CCPCH.

31. An apparatus comprising a processor and a memory, the memory containing program code executable by the processor for performing the following:
receiving a paging message including an uplink interference information;
obtaining the uplink interference information from the received paging message; and
responding to the received paging message using the uplink interference information by sending a RRC connection request message.

32. The apparatus of claim 31 wherein the memory further comprising program code for receiving the paging message on a Common Control Channel.

33. The apparatus of claim 32 wherein the apparatus is part of a UMTS and the Common Control Channel is an S-CCPCH.

34. The apparatus of claim 33 wherein the memory further comprising program code for storing the obtained uplink interference information, starting an expiration timer and considering the obtained uplink interference information valid until the expiration timer expires.

35. An apparatus for reducing call setup time comprising:
means for determining an uplink interference information; and
means for including the uplink interference information in a paging message to be sent on a Common Control Channel, thereby reducing call setup time.

36. The apparatus of claim 35 further comprising means for sending the paging message on the Common Control Channel.

37. The apparatus of claim 36 wherein the apparatus is part of a UMTS and the Common Control Channel is an S-CCPCH.

38. An apparatus for reducing call setup time comprising:
means for receiving a paging message including an uplink interference information;
means for obtaining the uplink interference information from the received paging message; and
means for responding to the received paging message using the uplink interference information by sending a RRC connection request message.

39. The apparatus of claim 38 further comprising means for receiving the paging message on a Common Control Channel.

40. The apparatus of claim 39 wherein the apparatus is part of a UMTS and the Common Control Channel is an S-CCPCH.

41. The apparatus of claim 40 further comprising means for storing the obtained uplink interference information, starting an expiration timer and considering the obtained uplink interference information valid until the expiration timer expires.

42. A computer-readable medium including program code stored thereon, comprising:
program code for causing a computer to determine an uplink interference information; and
program code for causing the computer to include the uplink interference information in a paging message to be sent on a Common Control Channel, thereby reducing call setup time.

43. The computer-readable medium of claim 42 further comprising program code for causing the computer to send the paging message on the Common Control Channel.

44. A computer-readable medium including program code stored thereon, comprising:
program code for causing a computer to receive a paging message including an uplink interference information;
program code for causing the computer to obtain the uplink interference information from the received paging message; and
program code for causing the computer to respond to the received paging message using the uplink interference information by sending a RRC connection request message.

45. The computer-readable medium of claim 44 further comprising program code for causing the computer to receive the paging message on a Common Control Channel.

46. The computer-readable medium of claim 45 wherein the Common Control Channel is an S-CCPCH.

47. The computer-readable medium of claim 46 further comprising program code for causing the computer to store the obtained uplink interference information, start an expiration timer and consider the obtained uplink interference information valid until the expiration timer expires.

48. A computer-readable medium including program code stored thereon, which when executed by at least one computer implement a method, comprising:
program code for determining an uplink interference information;
program code for including the uplink interference information in a paging message to be sent on a Common Control Channel;
program code for sending the paging message on the Common Control Channel;
program code for receiving the paging message;
program code for obtaining the uplink interference information from the received paging message; and
program code for responding to the received paging message using the uplink interference information by sending a RRC connection request message.

49. The computer-readable medium of claim 45 further comprising program code for storing the obtained uplink interference information, starting an expiration timer and considering the obtained uplink interference information valid until the expiration timer expires.
